(19) United States
(12) Patent Application Publication
(10) Pub. No.: US 2010/0137465 A1
(43) Pub. Date: Jun. 3, 2010

(54) PHOSPHATE ESTER FLAME RETARDANT AND RESINS CONTAINING SAME

(76) Inventors: Jeffrey Stowell, Wingdale, NY (US); Weihong Liu, Bridgewater, NJ (US)

Correspondence Address: DILWORTH & BARRESE, LLP, 1000 WOODBURY ROAD, SUITE 405, WOODBURY, NY, 11797, US

(21) Appl. No.: 12/522,070

(22) PCT Filed: Jan. 4, 2008
(86) PCT No.: PCT/US08/00172

§ 371 Date: Jan. 6, 2010

Related U.S. Application Data
(60) Provisional application No. 60/878,563, filed on Jan. 4, 2007.

(51) Int. Cl. C07F 9/6574; C07F 9/655; C09K 21/12

(52) U.S. Cl. 521/107; 558/86; 252/609; 524/117

(57) ABSTRACT

Certain cyclic phosphate ester compounds useful, inter alia, as halogen-free flame-retardant compounds, are disclosed. The compounds are particularly useful for providing flame retarded polyurethane foams. (I)

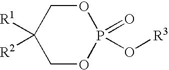

### FIELD OF THE INVENTION

This invention relates to cyclic phosphate esters and their use as flame retardants in synthetic resins such as polyurethane foams.

### BACKGROUND OF THE INVENTION

Many kinds of synthetic organic resins are combustible to one extent or another, some more than others. Where their potential for combustion possesses heightened safety and/or health risks, it is a general practice to add one or a mixture of flame retardants to such resins.

Flexible polyurethane foams are widely used as cushioning or padding materials, for example, in furniture and in automobiles, and it is known to incorporate fire-retardant additives in such foams. However, there are often considerable technical problems and toxicological concerns restricting the use of these flame retardants as is the case with conventional halogenated fire retardants.

Flame-retardant additives commonly used to make flame retarded polyurethane foams typically contain halogen compounds. However, for reasons of product sustainability there is a movement within the industry towards the use of non halogen-containing flame retardants.

Phosphate esters are known for incorporation in synthetic resins such as polyurethane foams where they function as flame retardants. It has now been discovered that certain novel cyclic phosphate esters alone, or in combination with one or more other flame retardants, incorporated into polyurethane foams results in flame retardant foam capable of meeting a variety of flame retardancy standards without the presence of halogen atoms.

### SUMMARY OF THE INVENTION

The present invention provides a phosphate compound of the formula:

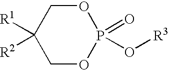

wherein, R¹ and R² are straight-chain or branched alkyl groups having from 1 to 6 carbon atoms, which optionally contains one or more non-terminal heteroatom substituents, R³ is a alkyl group containing at least one non-terminating hetero atom.

### DETAILED DESCRIPTION OF THE INVENTION

This invention is directed to certain cyclic phosphate alkoxyalkyl ester compounds which are particularly useful as halogen-free flame-retardant materials in flame retardant-effective amounts to any of a wide variety of resins to impart flame retardant properties thereto.

The novel phosphate esters of this invention are satisfactorily employed by themselves and, if desired, in combination with one or more other flame retardants, e.g., one or more organohalogen, oranophosphorous and/or melamine-based flame retardants as described, e.g., in U.S. Pat. No. 6,967,252. Melamine-based flame retardants as used herein includes melamine compounds, melamine per se, i.e., the compound 2,4,6-triamino s-triazine, and its flame retardant-effective derivatives.

In accordance with the present invention, it has unexpectedly been found that a mixture of an effective flame-retardant amount of a novel non-halogen cyclic alkoxyalkyl phosphate ester and a melamine compound incorporated into a polyurethane foam results in flame retarded foam capable of meeting a variety of flame retardancy standards, e.g., the California Technical Bulletin 117 test criteria, the Motor Vehicle Safety Standard 302 (MVSS 302) test criteria, and the stringent British Standard 5852 (BS 5852) test criteria.

The cyclic phosphate ester of the present invention is represented by the general formula:

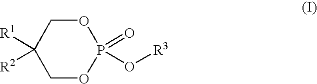

In formula (I), R¹ and R² have a carbon number of 1 to 6, which optionally contain additional heteroatom substituents, e.g., O, N, S, and the like, and can be straight-chain or branched alkyl groups, examples of which include straight-chain alkyl groups such as methyl, ethyl, n-propyl, n-butyl, n-pentyl, n-hexyl, etc., and branched alkyl groups such as iso-propyl, iso-butyl, sec-butyl, tert-butyl, iso-pentyl, tert-pentyl, neo-pentyl, iso-hexyl, and the like. Among these groups, straight-chain or branched alkyl groups having a carbon number of 1 to 4 are preferable, and methyl is the most preferable.

In formula (I), R³ is an alkyl group containing at least one non-terminating hetero atom. In one embodiment of the invention, R3 is an alkyl group containing at least one non-terminating oxygen atom substituent, e.g., butoxyethyl and ethoxyethyl compounds and the like. Other suitable R³ substituents include, for example, propoxyisopropyl; 2-propoxyethyl; 2-methoxyisopropyl; 2-(2-methoxyethoxy)ethyl; 2-(2-ethoxyethoxy)ethyl; 2-phenoxyethyl; 2-(methylthio)ethyl; 2-(methylthio)propyl; 2-(ethylthio)ethyl; N,N-diethyl-2-aminoethyl; N-t-butyl aminoethyl; N-n-butyl aminoethyl and the like.

Specific examples of phosphate esters in accordance with the invention include the following: cyclic neopentyl 2-butoxyethyl phosphate, cyclic neopentyl 2-ethoxyethyl phosphate, cyclic neopentyl 2-propoxyisopropyl phosphate, cyclic neopentyl 2-propoxyethyl phosphate, cyclic neopentyl 2-methoxyisopropyl phosphate, cyclic neopentyl 2-(2-methoxyethoxy)ethyl phosphate, cyclic neopentyl 2-(2-ethoxyethoxy)ethyl phosphate, and cyclic neopentyl 2-phenoxyethyl phosphate.

According to one specific embodiment of the invention, the cyclic phosphate ester of the invention has the following formula:

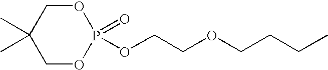

According to another specific embodiment of the invention, the cyclic phosphate ester of the invention has the following formula:

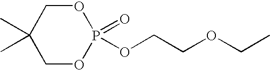

The phosphate esters of this invention can be prepared by reacting at least one trichlorophosphate with at least one hydroxyalkyl containing at least one non-terminal heteroatom under reduced temperature conditions (e.g., about 5-10° C. in a reactor) in at least the stoichiometrically required amounts, e.g., at least 1 mole of the chlorophosphate per mole of the glycol ether, to provide the corresponding dichloro-phosphate monoester, the latter then being reacted with a disubstituted propylene glycol of the general formula:

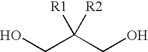

wherein R¹ and R² are as defined above, or ether and ester derivatives of pentaerythritol or trimethylolpropane to provide the product phosphate triester.

A general reaction sequence of the synthesis of the novel phosphate esters, e.g., neopentyl 2-butoxyethyl phosphate (NBEP), of the present invention is illustrated as follows:

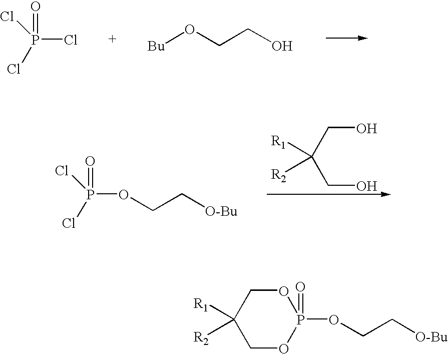

The phosphate esters of the invention can be added in flame retardant-effective amounts to any of a wide variety of resins to impart flame retardant properties thereto. Resins to which the phosphate esters can be added include, e.g., polyolefins such as polyethylene, polypropylene and polyethylene-co-propylene copolymer, polyvinyl chloride, polystyrene, polyacrylates, polymethacrylates, polycarbonates, polyesters, polyurethanes, and the like, blends of resins, as well as many other kinds of resins as described, e.g., in U.S. Pat. No. 6,967,252, the entire contents of which are incorporated by reference herein.

The phosphate esters of this invention are satisfactorily employed by themselves and, if desired, in combination with one or more other flame retardants, e.g., any of the organohalogen, organophosphorus, inorganic compounds and/or melamine-based flame retardants as described in, e.g., the aforementioned U.S. Pat. No. 6,967,252 and in U.S. Patent Application 2006/0208238, the contents of which are also incorporated by reference herein.

Suitable organophosphorus-based flame retardants that can be used with the phosphate esters of this invention include, but are not limited to, triethyl phosphate, ethyl diphenyl phosphate, dibutyl phenyl phosphate, butyl diphenyl phosphate, 2-ethylhexyl diphenyl phosphate, triphenyl phosphate, tricresyl phosphate, alkylated triaryl phosphates, such as butylated or isopropylated triphenyl phosphate, dimethyl methylphosphonate, dimethyl propylphosphonate and the like and mixtures thereof. Examples of organohalogen-based flame retardants suitable for use with the phosphate esters of the present invention include, e.g., tris(chloropropyl) phosphate and tris(dichloroisopropyl) phosphate, N-trifluoromethylmelamine, N-(2-chloroethyl)melamine, N-(3-bromophenyl)melamine and the like and mixtures thereof.

Examples of melamine-based flame retardants that can be used with the phosphate esters of this invention include, but are not limited to, melamine, N-methylmelamine, N-cyclohexylmelamine, N-phenylmelamine, N,N-dimethylmelamine, N,N-diethylmelamine, N,N-dipropylmelamine, N,N′-dimethylmelamine, N,N′,N″-trimethylmelamine, and the like. Also alcohol derivatives of melamine such as trimethylolmelamine or triethylolmelamine may be used. Melamine sulfate and melamine phosphates such as melamine orthophosphate, melamine polyphosphate, and dimelamine orthophosphate may also be used.

The phosphate ester flame retardants of the invention can be added to the host resin(s) employing any suitable procedure, e.g., utilizing an extruder or roll-type blender in the case of a thermoplastic resin and adding the flame retardant(s) to a thermoset resin-forming reaction mixture or component thereof in the case of a thermoset resin.

The flame retardant performance of polyurethane foams and polyisocyanurate foams can be significantly improved by the addition of one or more phosphate esters of this invention, with or without other flame retardant (s) such as those aforementioned. The flame retardant(s) can be introduced into these foams via the reaction mixtures from which the foams are produced. Typically, a polyurethane foam or polyisocyanurate foam-forming reaction mixture contains one or more polyols, e.g., polyether polyol or polyester polyol, polyisocyanates, chain extenders, silicone surfactants, blowing agents, catalysts and, if desired, other similarly known and conventional components.

The phosphate ester flame retardants of the invention can be reactive phosphate flame retardant(s), i.e., those in which R¹, R² and R³ can contain chemically reactive groups, e.g., hydroxyl, thiol or primary/secondary amine groups, the flame retardants will be chemically incorporated within the structure of the resulting foam. This chemical incorporation can be achieved by simply adding the reactive phosphate ester(s) to the resin-forming components mentioned above or to its polyol component.

The flame retardant(s) of the present invention can be non-reactive and any other non-reactive flame retardant(s) that may be utilized herein will be substantially uniformly incorporated into, and mechanically entrained within, the resulting foam.

In contrast to the non-reactive phosphate ester flame retardants, reactive phosphate flame retardant(s) will be chemically incorporated within the structure of the resulting foam. This chemical incorporation can be achieved by first reacting polyol, polyisocyanate and reactive phosphate ester(s) to provide a hydroxyl-terminated or isocyanate-terminate polyurethane prepolymer from which the polyurethane foam (or non-cellular polyurethane resin) is ultimately derived and/or to simply add the reactive phosphate ester(s) to the resin-forming components mentioned above or to its polyol component.

It is, of course, contemplated that both non-reactive and reactive phosphate ester flame retardant can be incorporated in a polyurethane foam or polyisocyanurate foam with the non-reactive flame retardant being mechanically entrained therein and the reactive flame retardant being chemically integrated in the foam structure.

The amounts of flame retardant(s) introduced into a resin or resin blend can vary widely provided that at least a flame retardant-effective amount is utilized. For many resins including those mentioned, the total amount of flame retardant (i.e., phosphate ester flame retardant(s) of this invention alone or in combination with one or more other flame retardants) can vary from about 0.5 to about 45 weight percent of the resin(s), preferably from about 3 to about 40 weight percent of the resin(s) and more preferably from about 5 to about 35 weight percent of the resin(s). Optimum amounts of specific flame retardant(s) for a specific resinous composition can be readily determined employing known and conventional procedures.

The advantages of this invention are illustrated by the following examples. The reactants, proportions and other specific conditions are presented as being typical and should not be construed to limit the invention unduly.

### EXAMPLES

Flame-retarded polyurethane foam Examples 1 and 2 and Comparative Examples 1-5 were hand mixed laboratory pours made in a box (free rise). The components of the formulation used to prepare Examples 1 and 2 and Comparative Examples 1-5 are identified in Table 1 below, shown as parts by weight in relation to 100 parts by weight of the polyol.

TABLE 1

| ADDITIVE | ADDITION LEVEL |
|---|---|
| Vorinol 3136 (polyether polyol | 100 |
| with an OH number of 54 | |
| available from Dow Chemical) | |
| FR - Phosphate (prepared by | 13 |
| Supresta, LLC) | |
| Melamine (Melamine 003 | 18 |
| Grade available from DSM) | |
| H₂O | 3.55 |
| D33LV/A-1: 3/1 ratio (Dabco | 0.23 |
| BLV catalyst available from | |
| Air Products) | |
| Silicone L-620 (Niax Silicone | 0.80 |
| L-620 available from General | |
| Electric Advanced Materials) | |
| Stannous Octoate T-10(Dabco | 0.55 |
| T-10 available from Air | |
| Products) | |
| TDI (Mondur TD-80 Grade A | 47.33 |
| available from Bayer Material | |
| Science) | |
| TDI Index | 110 |

The novel cyclic neopentyl 2-butoxyethyl phosphate (NBEP) flame retardant of Examples 1 and 2 was prepared as follows: 612 g (4 mol) of POCl₃ was placed in a reactor with an agitator, a thermometer, a nitrogen inlet, and a condenser connected to a scrubber as a nitrogen outlet. The scrubber was also connected to a vacuum system (water-pump). The reactor was cooled to 10° C., and 449 g (3.8 mol) of 2-butoxyenthanol was added dropwise to the reactor over a period of 4 hours. The temperature of the reactor was controlled at 5-10° C. After the 4 hour period, cooling of the reactor was stopped, and the reactor temperature allowed to increase on its own to 24° C. within 1 hour. The reactor was then cooled to 10° C., and 416.6 g (4.0 mol) of neopentyl glycol (NPG) was added. The reaction temperature was controlled at 10° C., after 30 minutes had passed, reactor cooling was stopped; the temperature of the reactor rose to 48° C. within 1 hour. Due to the presence of some unreacted POCl₃ after the original addition of 2-butoxyethanol, 31P NMR analysis confirmed the presence of about 5% neopentyl chlorophosphate (mol percentage of total phosphorous in NMR). The neopentyl chlorophosphate was consumed with the addition of 23.6 g (0.5 mol) of 2-butoxyethanol and 53 g (0.5 mol) of sodium carbonate to the reactor. The reaction proceeded under high temperature for 1 hour with agitation. After cooling the reaction mixture to room temperature, 200 ml of 10% aq. NaOH was added. The reaction mixture was stirred for 1 hour. The pH was then checked; if lower than 7.0, more aq. NaOH was added to the mixture. Product washing was continued until the pH of the water layer was in the range of 7-8. Finally, the product was dehydrated under vacuum at 50° C.

Examples 1 and 2 and Comparative Examples 1-5 were tested under the British Standard 5852 (BS 5852) test conditions and prepared from foam samples that measured 18″×18″×3″ for back and 12″×18″×3″ for bottom. The ignition source used was Crib #5 (17 grams); the reagent used was isopropyl alcohol (1.4 ml).

As presented in Table 2, the cured polyurethane foam of Examples 1 and 2 and Comparative Examples 1-5 included the following flame-retardant materials: cyclic neopentyl 2-butoxyethyl phosphate (NBEP); tris(chloropropyl)phosphate (TCPP); tris (dichloroisopropyl)phosphate (TDCP); 2,2-bis(chloromethyl)trimethylene bis(bis(2-chloroethyl)phosphate (V6); and melamine (obtained from the DSM Co. 99% having a particle size of 40 microns) respectively.

TABLE 2

| | | Air- | | BS- | Weight Loss |
|---|---|---|---|---|---|
| | Loading | flow | Density | 5852 | & Time |
| Comparative Ex. 1 | 13/20 | 2.2 | 2.1 | pass | 56.3 grams |
| TCPP/Melamine | | | | | 9 min 10 sec |
| Comparative Ex. 2 | 15/20 | 2.5 | 2.0 | pass | 44.4 grams |
| TCPP/Melamine | | | | | 8 min 10 sec |
| Comparative Ex. 3 | 18/20 | 2.3 | 2.0 | pass | 29.1 grams |
| TCPP/Melamine | | | | | 5 min 26 sec |
| Comparative Ex. 4 | 18/20 | 2.4 | 2.1 | pass | 58.8 grams |
| TDCP/Melamine | | | | | 5 min 45 sec |
| Comparative Ex. 5 | 18/20 | 2.3 | 2.1 | fail | 97.7 grams |
| V6/Melamine | | | | | 9 min 20 sec |
| Example 1 | 13/20 | 2.2 | 2.1 | pass | 50.7 grams |
| NBEP/Melamine | | | | | 4 min 30 sec |
| Example 2 | 18/20 | 2.2 | 2.1 | pass | 31.6 grams |
| NBEP/Melamine | | | | | 4 min 30 sec |

Examples 1 and 2 which contained mixtures of neopentyl 2-butoxyethyl phosphate and melamine, showed a performance similar, if not better than the most commonly used halogen containing flame retardant system on the market (TCPP/melamine).

While the process of the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

1. A phosphate compound of the formula: 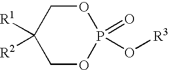
wherein, R¹ and R² are straight-chain or branched alkyl groups having from 1 to 6 carbon atoms, which optionally contains one or more non-terminal heteroatom substituents, R³ is a alkyl group containing at least one non-terminating hetero atom.

2. The phosphate of claim 1 wherein the heteroatoms in R¹, R², and R³ are at least one of O, S and N.

3. The phosphate of claim 1 wherein the heteroatom in R³ is O.

4. The phosphate of claim 1 wherein R¹ and R² are 1 to 4 carbon straight-chain or branched alkyl groups, which optionally contains one or more non-terminal heteroatom substituents.

5. The phosphate of claim 1 wherein R¹ and R² are independently selected from the group consisting of methyl, ethyl, n-propyl, n-butyl, n-pentyl, n-hexyl, iso-propyl, iso-butyl, sec-butyl, tert-butyl, iso-pentyl, tert-pentyl, neo-pentyl, and iso-hexyl, which optionally contains one or more non-terminal heteroatom substituents.

6. The phosphate of claim 3 wherein R¹ and R² are methyl.

7. The phosphate of claim 1 wherein R³ is selected from the group consisting of butoxyethyl, ethoxyethyl, propoxyisopropyl, 2-propoxyethyl, 2-methoxyisopropyl, 2-(2-methoxyethoxy)ethyl, 2-(2-ethoxyethoxy)ethyl, 2-phenoxyethyl, 2-(methylthio)ethyl, 2-(methylthio)propyl, 2-(ethylthio)ethyl, N,N-diethyl-2-aminoethyl, N-t-butyl aminoethyl, and N-n-butyl aminoethyl.

8. A phosphate of claim 1 selected from the group consisting of cyclic neopentyl 2-butoxyethyl phosphate, cyclic neopentyl 2-ethoxyethyl phosphate, cyclic neopentyl 2-propoxyisopropyl phosphate, cyclic neopentyl 2-propoxyethyl phosphate, cyclic neopentyl 2-methoxyisopropyl phosphate, cyclic neopentyl 2-(2-methoxyethoxy)ethyl phosphate, cyclic neopentyl 2-(2-ethoxyethoxy)ethyl phosphate, and cyclic neopentyl 2-phenoxyethyl phosphate.

9. A flame retardant composition comprising at least one phosphate of claim 1.

10. The flame retardant composition of claim 9 further comprising at least one different flame retardant.

11. The flame retardant composition of claim 10 wherein the different flame retardant is at least one member selected from the group consisting of organohalogen compound, organophosphorus compound and melamine compound.

12. The flame retardant composition of claim 10 wherein the phosphate is cyclic neopentyl 2-butoxyethyl phosphate and the different flame retardant is melamine.

13. A resin containing a flame retardant-effective amount of at least one phosphate of claim 1.

14. A resin containing a flame retardant-effective amount of the flame retardant composition of claim 9.

15-17. (canceled)

18. The resin of claim 13 which is a polyurethane foam.

19. The resin of claim 14 which is a polyurethane foam.

20-22. (canceled)

23. A polyurethane foam-forming reaction mixture which comprises:
a) polyol;
b) phosphate of claim 1;
c) polyisocyanate; and, optionally,
d) at least one different flame retardant, the total amount of (b) and (d) in the reaction mixture constituting a fire retardant effective amount in the foam obtained therefrom.

24. The reaction mixture of claim 23 wherein polyol (a) is a polyether polyol or polyester polyol.

25. The reaction mixture of claim 23 wherein polyol (a) is a polyether diol or polyester diol and polyisocyanate (c) is a diisocyanate.

26. The reaction mixture of claim 23 wherein the different flame retardant is at least one member selected from the group consisting of organohalogen compound, organophosphorus compound and melamine compound.

27. The reaction mixture of claim 23 wherein the phosphate is cyclic neopentyl 2-butoxyethyl phosphate and the different flame retardant is melamine.

28. The foam obtained from the polyurethane foam-forming reaction mixture of claim 23.

29-32. (canceled)
